(19) United States
(12) Patent Application Publication
(10) Pub. No.: US 2009/0237244 A1
(43) Pub. Date: Sep. 24, 2009

(54) Electronic Device, Printer and Multi-Functional Device

(75) Inventor: Atsushi FUJIMAKI, Shiojiri-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/408,267

(22) Filed: Mar. 20, 2009

(30) Foreign Application Priority Data
Mar. 21, 2008 (JP) 2008-073073

(51) Int. Cl. G08B 21/00

(52) U.S. Cl. 340/540

(57) ABSTRACT

An electronic device which obtains time from a real-time clock, the real-time clock keeping time with electric power supplied from a specific chargeable/dischargeable power supply, the real-time clock including: a discharge detecting unit which detects whether the power supply is discharging; a clock setup unit which sets a clock for the real-time clock; a clock setup flag which indicates whether the clock has been set by the clock setup unit; and a warning unit which issues a warning to encourage a user to set the clock in a period since the discharge of the power supply is detected until the clock is newly set, in which when the clock is set, the clock setup unit turns the clock setup flag on to indicate that the clock is set; when the warning unit issues a warning, the clock setup unit turns the clock setup flag off to indicate that the clock is not yet set; and the warning unit issues the warning when the clock setup flag is off.

### BACKGROUND

1. Technical Field

The present invention relates to an electronic device, a printer and a multi-functional device.

2. Related Art

Electronic devices, such as a printer, include a real-time clock (RTC) for printing the current time and for other purposes. The RTC usually has a dedicated power supply (e.g., a capacitor) connected thereto and keeps the current time when the main power supply of the electronic device is turned off.

JP-A-2001-45678 discloses turning on the main power supply to charge the backup power supply which supplies electric power to the RTC when the output voltage of the backup power supply becomes low.

In the disclosed system, however, the backup power supply cannot be charged unless the main power supply is turned on, and thus the RTC may become inaccurate. Accordingly, general electronic devices issue a warning in response to lowered output voltage of the backup power supply so as to encourage a user to set the clock.

The electronic devices, however, stop encouraging the user to set the clock when the backup power supply is charged even when the clock is not yet set. The user is therefore not aware of inaccurate clock of the electronic devices.

### SUMMARY

The invention provides a technique for suitably encouraging the user to set the clock.

An electronic device according to an aspect of the invention obtains time from a real-time clock, the real-time clock keeping time with electric power supplied from a specific chargeable/dischargeable power supply, the real-time clock including: a discharge detecting unit which detects whether the power supply is discharging; a clock setup unit which sets a clock for the real-time clock; a clock setup flag which indicates whether the clock has been set by the clock setup unit; and a warning unit which issues a warning to encourage a user to set the clock in a period since the discharge of the power supply is detected until the clock is newly set, in which when the clock is set, the clock setup unit turns the clock setup flag on to indicate that the clock is set; when the warning unit issues a warning, the clock setup unit turns the clock setup flag off to indicate that the clock is not yet set; and the warning unit issues the warning when the clock setup flag is off.

According to the electronic device of the invention, a user can suitably be encouraged to set the clock.

### BRIEF DESCRIPTION OF THE DRAWINGS

The invention will be described with reference to the accompanying drawings, wherein like numbers reference like elements.

FIG. 1 shows a hardware configuration of a multi-functional device according to an embodiment of the invention.

FIG. 2 shows a functional configuration of the multi-functional device.

FIG. 3A illustrates an initial setup flag.

FIG. 3B illustrates a clock setup flag.

FIG. 4 is a flowchart of a start-up process executed by the multi-functional device.

FIG. 5 is a flowchart of an initial setup executed by the multi-functional device.

FIG. 6A shows an exemplary warning message displayed on a panel.

FIG. 6B shows an exemplary language setup screen displayed on the panel.

FIG. 6C shows an exemplary time difference setup screen displayed on the panel.

FIG. 6D shows an exemplary clock setup screen displayed on the panel.

### DESCRIPTION OF EXEMPLARY EMBODIMENTS

Referring now to the drawings, an embodiment of the invention will be described.

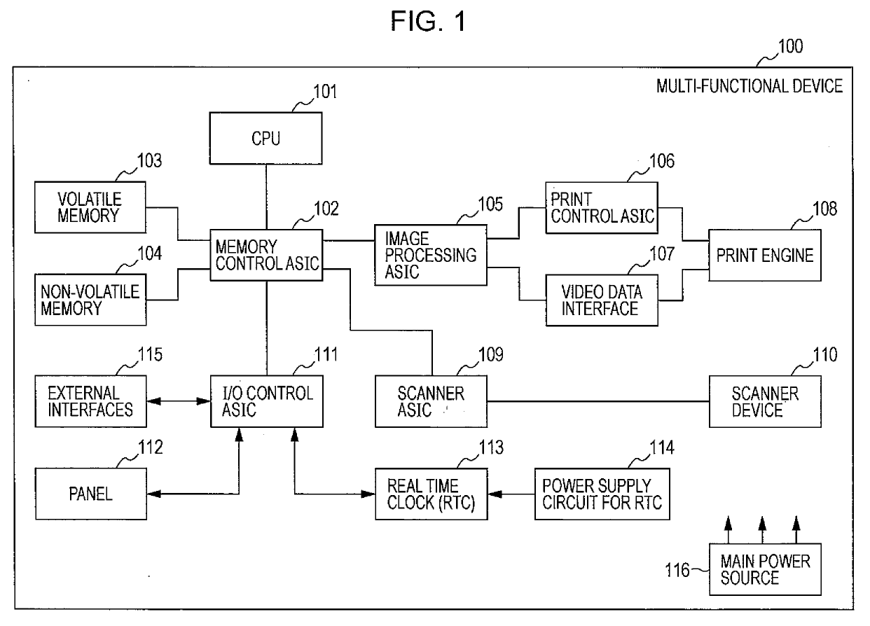

FIG. 1 is a schematic block diagram showing a hardware configuration of a multi-functional device 100 to which the present embodiment of the invention is applied.

As shown in FIG. 1, the multi-functional device 100 includes a central processing unit (CPU) 101, a memory control application-specific integrated circuit (ASIC) 102, a volatile memory 103 and a non-volatile memory 104.

The CPU 101 executes programs to control the entire multi-functional device 100.

The memory control ASIC 102 controls memories connected to the multi-functional device 100. For example, the memory control ASIC 102 controls the volatile memory 103 which temporarily stores data and programs and the non-volatile memory 104 which stores programs.

The volatile memory 103 is a semiconductor memory which loses stored information when the power supply is turned off. The volatile memory 103 may be a random access memory (RAM), a dynamic random access memory (DRAM) and a synchronous dynamic random access memory (SDRAM). The non-volatile memory 104 is a semiconductor memory which maintains stored information even after the power supply is turned off. The non-volatile memory 104 may be a flash memory and a read-only memory (ROM).

The multi-functional device 100 further includes an image processing ASIC 105, a print control ASIC 106, a video data interface 107 and a print engine 108.

The image processing ASIC 105 is circuit(s) which converts to-be-printed data (e.g., image data) into data formatted for printing. In particular, the image processing ASIC 105 executes color conversion, compression, extension, binarization or other processes to the to-be-printed data to generate data formatted for printing.

The print control ASIC 106 controls the print engine 108. In particular, the print control ASIC 106 generates to-be-printed image data based on the data formatted for printing supplied from the image processing ASIC 105 and sends the image data to the print engine 108 for printing.

The video data interface 107 sends video data to the print engine 108 for printing. In particular, the video data interface 107 develops the data formatted for printing supplied from the image processing ASIC 105 to the video data for every page and sends the developed video data to the print engine 108 for printing.

The print engine 108 includes a print head, a carriage, a toner cartridge, a photoreceptor drum, a laser beam irradiation mechanism, a paper transporting mechanism and a mechanism for feeding and discarding paper. The print engine 108 prints data supplied from the print control ASIC 106 or the video data interface 107 on a printing medium. The print engine 108 also prints time at which the data is transmitted from the RTC 113, which will be described later, on a printing medium (e.g., in a header) based on an instruction from the CPU 101.

The multi-functional device 100 further includes a scanner ASIC 109 and a scanner device 110.

The scanner ASIC 109 controls the scanner device 110. The scanner ASIC 112 sends image data generated by the scanner device 115 to the memory control ASIC 130.

The scanner device 110 reads original documents, such as photograph and illustration, using an image sensor based on an instruction from the scanner ASIC 109, converts the read information into digital data so as to generate image data.

The multi-functional device 100 further includes an I/O control ASIC 111, a panel 112, a real-time clock (RTC) 113, a power supply circuit for RTC 114, external interfaces 115 and a main power supply 116.

The I/O control ASIC 111 controls various I/O devices. For example, the I/O control ASIC 111 controls the panel 112, the RTC 113, the power supply circuit for RTC 114 and the external interfaces 115. The I/O control ASIC 111 sends the to-be-printed data received via the external interfaces 115 to the volatile memory 103 in a direct memory access (DMA) format. The I/O control ASIC 111 obtains voltage potential output by the power supply circuit for RTC 114 toward the RTC 113.

The panel 112 may be a liquid crystal display for displaying data to be presented to the user and various setup screens. The user provides instructions by touching the panel 112. The panel 112 displays, for example, a message for encouraging the user to set the clock of the RTC 113, which will be described later.

The main power supply 116 supplies electric power provided from a home/office wall socket to each unit of the multi-functional device 100.

The power supply circuit for RTC 114 supplies electric power to the RTC 113, which will be described later, separately from the main power supply 116. The power supply circuit for RTC 114 includes a built-in high-performance capacitor called a super capacitor, a gold capacitor or an electric double-layer capacitor. The power supply circuit for RTC 114 accumulates (i.e., charges) the electric power supplied from the main power supply 116 in the capacitor when the main power supply 116 is on. The power supply circuit for RTC 114 emits (i.e., discharges) the electric power accumulated in the capacitor to when the main power supply 116 is off so as to cause the RTC 113 to continuously operate.

The RTC 113 keeps the current time with the electric power supplied from the RTC power supply circuit 114 even when the main power supply 116 is turned off. For example, the RTC 113 operates with a clock provided separately from the clock of the CPU 101 and keeps current year, month, day, hour, minute and second as separate data. The RTC 113 outputs digital signals representing the current time to the CPU 101 in response to the encouragement from the CPU 101.

The external interfaces 115 are provided for transmitting and receiving data between devices connected to the external interfaces 115. The devices may include input devices, such as switches and buttons, output devices, such as displays, USB devices, devices for parallel communication and devices for network communication. The switches may include a main power supply switch for turning on and off the electric power from the main power supply 116 to each unit.

The multi-functional device 100 to which the present embodiment is applied has the above-described configuration, but the multi-functional device 100 is not limited thereto. For example, the multi-functional device 100 may be a printer with no scanning function (i.e., with no scanner ASIC 119 or no scanner device 110). The multi-functional device 100 may be a scanner device with no printing function (i.e., with no print control ASIC 106, no video data interface 107 or no print engine 108).

Alternatively, the multi-functional device 100 may be an electronic device which has neither printing function nor scanner function. The multi-functional device 100 may have a facsimile function.

Next, a functional configuration of the multi-functional device 100 will be described.

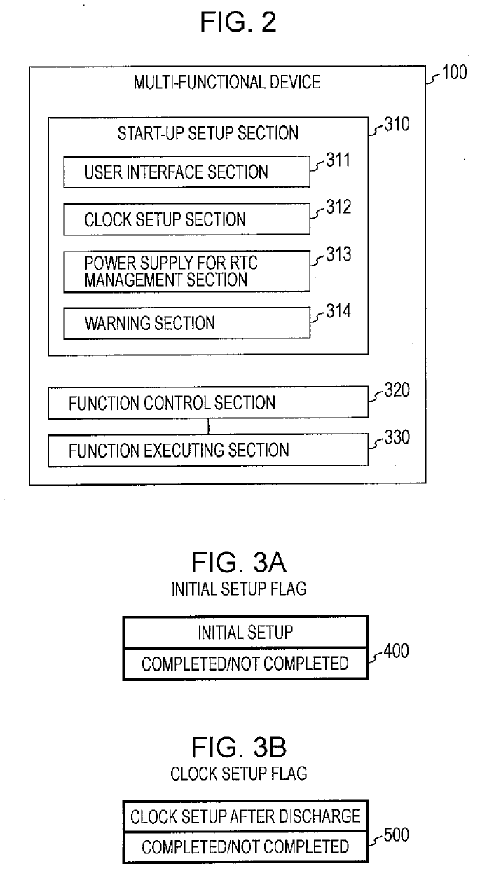

FIG. 2 is a block diagram which shows an exemplary functional configuration of the multi-functional device 100. As shown in FIG. 2, the multi-functional device 100 includes a start-up setup section 310, a function control section 320 and a function executing section 330.

The start-up setup section 310, the function control section 320 and the function executing section 330 are provided as software or hardware built when the CPU 101 executes predetermined programs or when the components shown in FIG. 1 are operated.

The start-up setup section 310 executes various setup processes during system start-up of the multi-functional device 100. In particular, the start-up setup section 310 executes the following processes: a process for the initial setup which includes a language setup, a time difference setup and a clock setup for RTC 113 in accordance with user instructions; a process for detecting a discharging state of the power supply circuit for RTC 114 (i.e., whether the output voltage potential of the power supply circuit for RTC 114 is below a predetermined threshold value); and a process of issuing a warning to encourage the user to set the clock.

The start-up setup section 310 manages an initial setup flag 400 which indicates whether the clock setup is completed among other processes executed during the initial setup (i.e., the language setup, the time difference setup and the clock setup). FIG. 3A illustrates the initial setup flag 400. The initial setup flag 400 stores data indicating that the clock setup is completed or not yet completed. When the clock setup is completed during the initial setup, the start-up setup section 310 turns the initial setup flag 400 on to indicate completion of the clock setup. When the initial setup is completed without setting the clock, the start-up setup section 310 turns the initial setup flag 400 off to indicate that the clock setup is not yet completed. The initial setup flag 400 is stored in the non-volatile memory 104 or a dedicated resistor (not shown) and is maintained even after the power supply 116 is turned off.

The start-up setup section 310 which executes the above processes includes a user interface section 311, a clock setup section 312, a power supply for RTC management section 313 and a warning section 314.

The user interface section 311 receives user instructions regarding the language setup, the time difference setup and the clock setup.

The clock setup section 312 sets the current time kept by the RTC 113. For example, the clock setup section 312 separately updates the data-regarding year, month, day, hour, minute and second kept by the RTC 113.

The clock setup section 312 manages a clock setup flag 500 indicating that the clock setup of the RTC 113 is completed or not yet completed after the discharge of the power supply circuit for RTC 114. FIG. 3B illustrates the clock setup flag 500. The clock setup flag 500 stores data indicating that the clock setup is completed or not yet completed after the discharge of the power supply circuit for RTC 114. When the clock setup is completed after the discharge of the power supply circuit for RTC 114, the clock setup section 312 turns the clock setup flag 500 on to indicate completion of the clock setup after the discharge. If the power supply circuit for RTC 114 discharges, the clock setup section 312 turns the clock setup flag 500 off to indicate that the clock setup is not yet completed after the discharge. The clock setup flag 500 is stored in the non-volatile memory 104 or a dedicated resistor (not shown) and is maintained even after the power supply 116 is turned off.

The power supply for RTC management section 313 detects the discharging state of the power supply circuit for RTC 114. In particular, the power supply for RTC management section 313 obtains the output voltage potential from the power supply circuit for RTC 114, determines that the power supply circuit for RTC 114 is in the discharging state when the obtained potential is below a predetermined threshold value and determines that the power supply circuit for RTC 114 is a charging state when the obtained potential is above the threshold value.

The warning section 314 issues a warning to encourage the user to set the clock. In particular, the warning section 314 refers to the clock setup flag 500 and displays a message for encouraging the user to set the clock on the panel 112 if the clock setup flag 500 is off.

The function control section 320 controls printing and scanning of an original document in the multi-functional device 100. For example, the function control section 320 generates to-be-printed image data based on the to-be-printed data and sends instructions to the function executing section 330 to print the generated to-be-printed image data. The function control section 320 also sends instructions to the function executing section 330 to scan the original document placed on a platen of the scanner device 110.

The function executing section 330 causes the print engine 108 to print on a printing medium, such as a sheet of printing paper, according to the instructions of the function control section 320. The function executing section 330 also causes the scanner device 110 to scan the original document according to the instructions of the function control section 320.

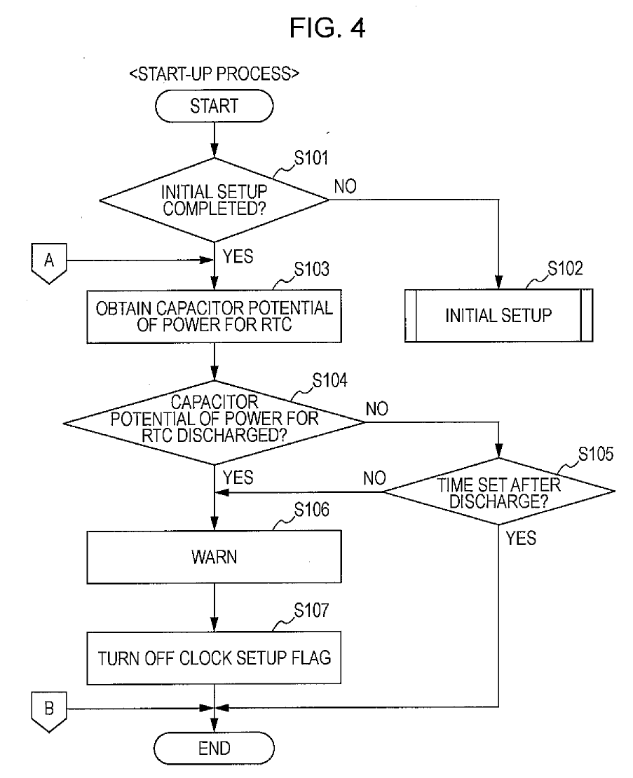

Next, characteristic operation of the thus-configured multi-functional device 100 will be described. FIG. 4 is a flowchart showing a process executed by the multi-functional device 100 during system start-up.

The start-up setup section 310 of the multi-functional device 100 starts the process to be executed during system start-up when the electric power supply of the main power supply 116 is turned on. In particular, when signals for turning on the main power supply switch connected to the external interfaces 115 are supplied to the CPU 101, the CPU 101 reads a predetermined program from the non-volatile memory 104 to the volatile memory 103 and starts the process to be executed during system start-up.

After the process to be executed during system start-up is started, the start-up setup section 310 determines whether the clock setup included in the initial setup is completed (step S101). In particular, the CPU 101 refers to the initial setup flag 400 and determines whether the flag 400 is on (i.e., completed) or off (i.e., not completed).

If negative in step S101, i.e., if the start-up setup section 310 determines that the initial setup flag 400 is off and thus the clock setup is not yet completed, the routine proceeds to step S102 where the initial setup is executed. The procedure of the initial setup will be described in detail later.

If affirmative in step S101, i.e., if the start-up setup section 310 determines that the initial setup flag 400 is on and thus the clock setup is completed), the routine proceeds to step S103.

Subsequently, the power supply for RTC management section 313 obtains the output voltage potential of the power supply circuit for RTC (i.e., the capacitor) 114 (step S103). In particular, the I/O control ASIC 111 obtains potential of the voltage currently output to the RTC 113 from the power supply circuit for RTC 114 and sends the obtained potential to the CPU 101.

Subsequently, the power supply for RTC management section 313 detects the state of the power supply circuit for RTC 114 based on the potential obtained in step S103 and determines that the power supply circuit for RTC 114 is in a discharging state (step S104). In particular, the CPU 101 compares a predetermined threshold value stored in the non-volatile memory 104 and the potential obtained in step S103 and determines the state of the power supply circuit for RTC 114.

If affirmative in step S104, i.e., if the power supply for RTC management section 313 determines that the potential obtained in step S103 is below the predetermined threshold value, the power supply circuit for RTC 114 is determined to be in the discharging state and the routine proceeds to step S106. If negative in step S104, i.e., if the power supply for RTC management section 313 determines that the potential obtained in step S103 is above the predetermined threshold value, the power supply circuit for RTC 114 is determined not to be in the discharging state (i.e., be in the charging state) and the routine proceeds to step S105.

Subsequently, the clock setup section 312 determines whether the clock setup is completed after the discharge (step S105). In particular, the CPU 101 refers to the clock setup flag 500 and determines whether the flag 500 is on (i.e., the clock setup is completed) or off (i.e., the clock setup is not yet completed).

If negative in step S105, i.e., if the clock setup section 312 determines that the clock setup flag 500 is off, the routine proceeds to step S106. If affirmative in step S105, i.e., if the clock setup section 312 determines that the clock setup flag 500 is on, the current time kept by the RTC 113 has been suitably set and the process executed during system start-up is completed.

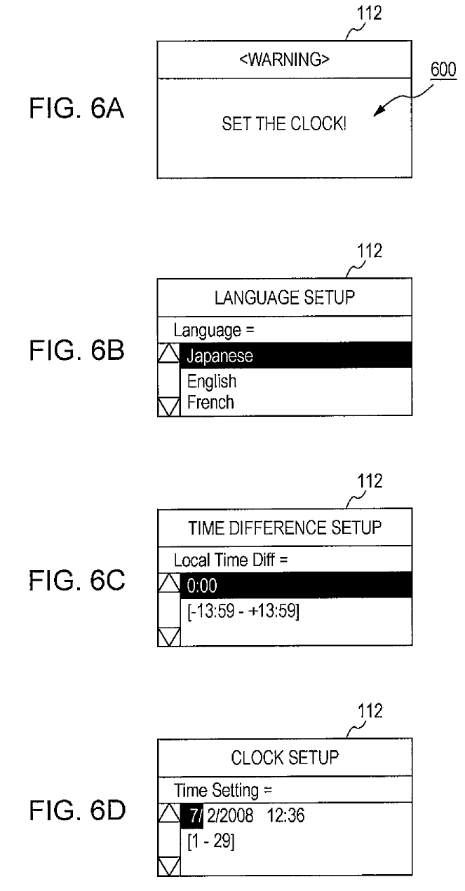

Subsequently, the warning section 314 issues a warning for encouraging the user to set the clock (step S106). In particular, the CPU 101 causes a warning message 600 to be displayed on the panel 112 via the I/O control ASIC 111. An exemplary warning message 600, “set the clock!” herein, displayed on the panel 112 is shown in FIG. 6A.

In the present embodiment, the warning of step S106 is issued not only when the power supply circuit for RTC 114 is in the discharging state (i.e., if affirmative in step S104), but also when the power supply circuit for RTC 114 is in the charging state and the clock of the RTC 113 is not yet set. In this manner, the user recognizes incomplete setup of the clock of the RTC 113 even if the power supply circuit for RTC 114 is in the charging state.

Subsequent to step S106, the clock setup section 312 turns the clock setup flag 500 off (step S107). In particular, the CPU 101 accesses the non-volatile memory 104 or a dedicated register and turns the clock setup flag 500 off indicating that the clock setup is not yet completed.

The start-up setup section 310 then completes the process executed during system start-up.

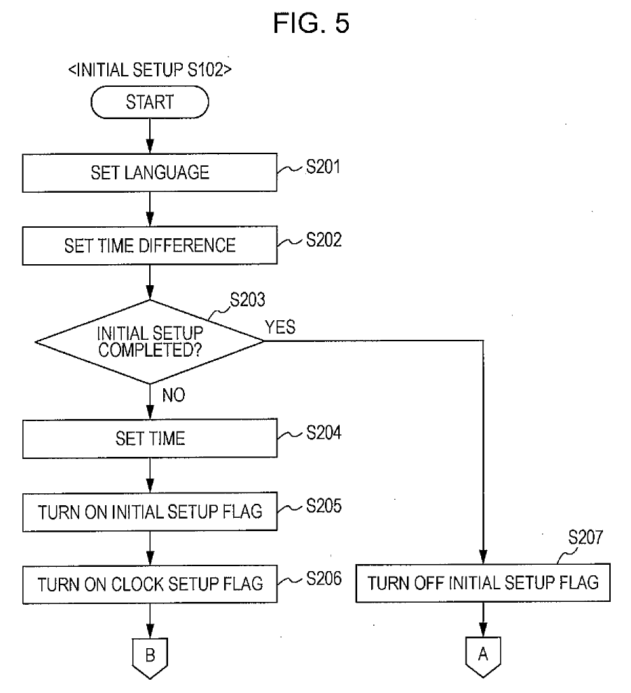

Next, the procedure of the initial setup during system start-up will be described in detail. FIG. 5 is a flowchart of the initial setup executed by the multi-functional device 100.

The start-up setup section 310 starts the initial setup when the routine of the process to be executed during system start-up shown in FIG. 4 proceeds to step S102.

Upon starting the initial setup, the start-up setup section 310 first sets the language to be used in the multi-functional device 100 (i.e., the language setup) (step S201). In particular, the CPU 101 causes a language setup screen to be displayed on the panel 112 via the I/O control ASIC 111. FIG. 6B illustrates an exemplary language setup screen displayed on the panel 112. As shown in FIG. 6B, the CPU 101 causes the language options (e.g., Japanese, English and French) to be displayed. The user interface section 311 receives a user instruction for selecting one of the language options (e.g., the I/O control ASIC 111 sends the user instruction received on the panel 112 to the CPU 101). The CPU 101 then registers the selected language in, for example, the non-volatile memory 104 as the language to be used in the multi-functional device 100.

Subsequently, the start-up setup section 310 sets the time difference of the local area where the multi-functional device 100 is used (i.e., the time difference setup) (step S202). In particular, the CPU 101 causes a time difference setup screen to be displayed on the panel 112 via the I/O control ASIC 111. FIG. 6C illustrates an exemplary time difference setup screen displayed on the panel 112. As shown in FIG. 6C, the CPU 101 causes the hour and minute to be displayed for setting the time difference. The user interface section 311 receives a user instruction for specifying the hour and minute (e.g., the I/O control ASIC 111 sends the user instruction received on the panel 112 to the CPU 101). The CPU 101 registers the hour and minute in, for example, the non-volatile memory 104 as the time difference of the multi-functional device 100.

Subsequently, the start-up setup section 310 determines whether an instruction for completing the initial setup has been issued (step S203). In particular, if affirmative in step S203, i.e., if the CPU 101 has received the instruction for completing the initial setup from the input device connected to the external interfaces 115 (e.g., by the user pressing BACK button), the routine proceeds to step S207. If negative in step S203, i.e., if the CPU 101 has not received any instruction for completing the initial setup in a predetermined period after the instruction was received in step S202, the routine proceeds to step S204.

In step S204, the clock setup section 312 sets the current time kept by the RTC 113 (i.e., the clock setup) (step S204). In particular, the CPU 101 causes a clock setup screen to be displayed on the panel 112 via the I/O control ASIC 111. FIG. 6D illustrates an exemplary clock setup screen displayed on the panel 112. As shown in FIG. 6D, the CPU 101 causes year, month, day, hour and minute to be displayed for the clock setup. The user interface section 311 receives a user instruction for specifying the year, month, day, hour and minute (e.g., the I/O control ASIC 111 sends the user instruction received on the panel 112 to the CPU 101). The CPU 101 sets the specified year, month, day, hour and minute as the current time of the RTC 113.

Subsequently, the start-up setup section 310 turns the initial setup flag 400 on (step S205). In particular, the CPU 101 accesses the non-volatile memory 104 or a dedicated register and turns the initial setup flag 400 on indicating that the clock setup is completed.

The clock setup section 312 also turns the clock setup flag 500 on (step S206). In particular, the CPU 101 accesses the non-volatile memory 104 or a dedicated register and turns the clock setup flag 500 on indicating that the clock setup is completed after the discharge. In this manner, no more warning will be issued in step S106 by the multi-functional device 100 after the clock setup is completed.

The start-up setup section 310 then completes the process executed during system start-up.

On the other hand, the start-up setup section 310 turns the initial setup flag 400 off (step S207). In particular, the CPU 101 accesses the non-volatile memory 104 or a dedicated register and turns the initial setup flag 400 off indicating that the clock setup is not yet completed. In this manner, the multi-functional device 100 continues issuing warnings in step S106 until the clock setup in the initial setup is completed.

The start-up setup section 310 then completes the initial setup and the routine proceeds to step S103 of the process executed during system start-up.

As described above, the multi-functional device 100 executing the processes for system start-up and initial setup suitably encourages the user to set the clock. For example, even if the power supply circuit for RTC 114 is not in the discharging state, the multi-functional device 100 may encourage the user to set the clock unless the clock of the RTC 113 is not yet set after the discharge.

The invention is not limited to those described and various modifications and applications may be made to the described embodiment.

For example, although the clock setup in step S204 is executed when the user instruction is received via the input device such as the panel 112, the invention is not limited thereto. The clock of the RTC 113 may alternatively be set with the current time obtained from a network time protocol (NTP) server that is network-connected to the multi-functional device 100.

The entire disclosure of Japanese Patent Application No. 2008-073073, filed Mar. 21, 2008 is expressly incorporated by reference herein.

What is claimed is:

1. An electronic device which obtains time from a real-time clock, the real-time clock keeping time with electric power supplied from a specific chargeable/dischargeable power supply, the real-time clock comprising:
a discharge detecting unit which detects whether the power supply is discharging;
a clock setup unit which sets a clock for the real-time clock;
a clock setup flag which indicates whether the clock has been set by the clock setup unit; and
a warning unit which issues a warning to encourage a user to set the clock in a period since the discharge of the power supply is detected until the clock is newly set,
wherein:
when the clock is set, the clock setup unit turns the clock setup flag on to indicate that the clock is set;
when the warning unit issues a warning, the clock setup unit turns the clock setup flag off to indicate that the clock is not yet set; and
the warning unit issues the warning when the clock setup flag is off.

2. An electronic device according to claim 1, wherein the warning unit issues the warning for every start-up event of the electronic device if the clock setup unit is not newly set the clock.

3. An electronic device according to claim 1, further comprising a panel connected to the electronic device for displaying text data, wherein the warning unit causes a message regarding the warning to be displayed on the panel.

4. A printer which includes a real-time clock, the real-time clock keeping time with electric power supplied from a specific chargeable/dischargeable power supply, the real-time clock comprising:
a discharge detecting unit which detects whether the power supply is discharging;
a clock setup unit which sets a clock for the real-time clock;
a clock setup flag which indicates whether the clock has been set by the clock setup unit; and
a warning unit which issues a warning to encourage a user to set the clock in a period since the discharge of the power supply is detected until the clock is newly set,
wherein:
when the clock is set, the clock setup unit turns the clock setup flag on to indicate that the clock is set;
when the warning unit issues a warning, the clock setup unit turns the clock setup flag off to indicate that the clock is not yet set; and
the warning unit issues the warning when the clock setup flag is off.

5. A multi-functional device which includes a real-time clock, the real-time clock keeping time with electric power supplied from a specific chargeable/dischargeable power supply, the real-time clock comprising:
a discharge detecting unit which detects whether the power supply is discharging;
a clock setup unit which sets a clock for the real-time clock;
a clock setup flag which indicates whether the clock has been set by the clock setup unit; and
a warning unit which issues a warning to encourage a user to set the clock in a period since the discharge of the power supply is detected until the clock is newly set,
wherein:
when the clock is set, the clock setup unit turns the clock setup flag on to indicate that the clock is set;
when the warning unit issues a warning, the clock setup unit turns the clock setup flag off to indicate that the clock is not yet set; and
the warning unit issues the warning when the clock setup flag is off.
